(19) United States
(12) Patent Application Publication
(10) Pub. No.: US 2009/0035186 A1
(43) Pub. Date: Feb. 5, 2009

(54) APPARATUS AND METHOD FOR DISPENSING LIQUID UTILIZING FLOW OF FLUID

(76) Inventor: Felix H. Yiu, Northridge, CA (US)

Correspondence Address: CHARLES C.H. WU, 98 DISCOVERY, IRVINE, CA, 92618-3105, US

(21) Appl. No.: 11/830,683

(22) Filed: Jul. 30, 2007

(51) Int. Cl. B01L 3/02; G01F 11/28

(52) U.S. Cl. 422/100; 222/1

(57) ABSTRACT

An apparatus for accurately and precisely aspirating and dispensing liquid from a in the nano-liter range without contacting the syringe tip to the target reservoir during dispensing; and a method to utilize such an apparatus. Such an apparatus utilizes a partially collapsible syringe tip that compresses when subjected to pressurized fluid around its outer surface area to discharge a liquid at the tip of said partially collapsible syringe tip with a high velocity. Such a discharge of liquid at such a high speed allows even the smallest amount of liquid in the nano-liter range to be dispensed to a target reservoir without contacting the target reservoir.

### BACKGROUND OF THE INVENTION

1. Technical Field of the Invention

The invention relates to a method and apparatus for aspirating and dispensing micro-volumes of liquid without allowing the tip to come in contact with the target receptacle. This invention allows a relative small amount of liquid to be discharged from the tip of any syringe type apparatus. This discharge is accomplished by a compression of the collapsible syringe tip allowing the liquid to be ejected at a high velocity. Ultimately, the high velocity discharge allows such syringe type apparatus to be suspended over the target receptacle, eliminating contact between the syringe tip and the content of the target receptacle; preventing contaminants.

2. Description of the Related Art

During biomedical and pharmaceutical research, precise and accurate measurements of liquid are often essential to ensure proper results. When experiments are conducted in large scales such as milliliter ranges, precisions in the nano-liter range are insignificant to the outcome of the experimentation. However, as technology improves, syringes and pipettors are now capable of dispensing liquid in the nano-liter range instead of milliliter ranges. This type of precise dispensing is hard to achieve, as the capillary effect creating a convex liquid tip prevents a small amount of liquid to be aspirated from the syringe with any sort of accuracy. The capillary effect is generated by the surface tension between the inner surface of the syringe tip and the liquid; consequently, such surface tension prevents a small amount of liquid to be accurately dispensed from the syringe tip.

In order to address the capillary effect discussed above, nano-liter syringe tips often immerse themselves in the target receptacle already filled with fluid to properly dispense the correct amount of liquid. However, as it is blatantly obvious, such attempts to address the undesirable capillary effect within a syringe tip create a new problem of undesirable contaminants. Contaminants occur when residual amount of liquid from previous samples to be introduced are left in the target receptacles. Although contaminants in small amounts do not generally affect the desired results in large scale experimentations in the milliliter range, these small contaminants are devastating in nano-liter experimentations.

Capillary based systems have been used to address this issue of nano-liter dispensing by impinging the tip of the syringe into the floor of the target reservoir. When the tip of the syringe comes in contact with another surface, the surface tension along the internal walls of the syringe tip is released, causing even nano-liter amount of liquid to be dispensed from a syringe tip. These capillary based systems although effective in addressing the precision dispensing issue, is completely ineffective in creating a non-contact method of aspiration that is required in addressing the contaminant issue.

Currently in the art, there are no apparatus that is capable of addressing this issue of nano-liter dispensing without contacting the syringe tip with the target reservoir.

Due to the foregoing, it can be seen that there is a need in the art for an apparatus and method of dispensing liquid in the nano-liter range without allowing the tip of the syringe to come in contact with the target reservoir. Moreover, it will be desirable to be able to achieve this on multiple syringes at once, as experimentation of chemical reactions often requires multiple samples.

Consequently, it will be an advance in the art to provide an apparatus to utilize a compressed fluid source to collapse a syringe tip that is partially compressible allowing the air that is within the internal walls of the compressible portion to push out any liquid that is held in the bottom tip of syringe. Moreover, such an innovation will allow for an effective, efficient, and contaminant free way of allowing nano-liter dispensing of liquid from a syringe.

### SUMMARY OF THE INVENTION

To minimize the limitations found in the prior art, and to minimize other limitations that will be apparent upon the reading of the specifications, the present invention provides a method and apparatus to dispense a nano-liter amount of liquid from a syringe tip or any tip without making contact with the target receptacle. This is accomplished through a partially collapsible syringe tip that collapses when subjected to a high pressure of fluid, thus overcoming the surface tension holding the fluid in place; ejecting the liquid out of the syringe at a high speed without coming in contact with the target receptacle.

An apparatus in accordance with the present invention for dispensing a liquid comprising of, a partially collapsible syringe tip; a fluid tight chamber partially enclosing said partially collapsible syringe tip; a set of valves juxtaposed at both sides of said fluid chamber controlling a flow of fluid into said fluid chamber; and a compressed fluid source for supply said flow of fluid; wherein said flow of fluid exerts a force on said enclosed portion of said partially collapsible syringe tip to dispense said liquid from said syringe tip.

An additional apparatus in accordance with the present invention for dispensing a liquid comprising of, a fluid chamber partially enclosing a partially collapsible syringe tip, said partially collapsible syringe tip further comprising: a first rigid portion at a proximal end of said partially collapsible syringe tip, a second rigid portion at a distal end of said partially collapsible syringe tip, and a collapsible portion connectively placed between said first rigid portion and said second rigid portion adapted to be enclosed by said fluid chamber; wherein said collapsible portion collapses when subjected to a pressurized fluid.

Moreover, a method in accordance with the present invention for dispensing a liquid comprises: enclosing a portion of a partially collapsible syringe tip in a fluid chamber; opening a set of valves juxtaposed at both sides of said fluid chamber controlling a flow of fluid into said fluid chamber; and allowing said flow of fluid into said fluid chamber; wherein said flow of fluid exerts a force on said partially collapsible syringe tip to dispense said liquid.

It is an objective of the present invention to dispense nano-liter amount of liquid from a syringe tip without contaminating the target receptacle.

It is another objective of the present invention to dispense a liquid in a non-contact fashion.

It is yet another objective of the present invention to dispense nano-liter amount of liquid from a syringe tip without contaminating the target receptacle in a simple inexpensive manner.

It is yet another objective of the present invention to achieve high speed dispensing of the liquid.

It is yet another objective of the present invention to be able to control precise aspiration volume within the syringe tip.

It is yet another objective of the present invention to dispense liquid from multiple syringes simultaneously.

It is yet another objective of the present invention to dispense the same amount of precise liquid from multiple syringes simultaneously.

It is yet another objective of the present invention to dispense nano-liter liquid without any fine control of the compressed fluid flow.

It is yet another objective of the present invention to utilize compressed fluid to collapse a collapsible portion of the syringe tip to eject liquid out of the syringe tip.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 shows a prospective view of one embodiment of the current invention with all components.

FIG. 2 shows a prospective view of the syringe and fluid chamber of the current invention.

FIG. 3 shows a front view of the syringe and fluid chamber that is partially sectioned to show the inner workings of syringe tip.

FIG. 4(a) shows a prospective view of the syringe and tip of the current invention before discharge of the liquid.

FIG. 4(b) shows a prospective view of the syringe and tip of the current invention discharging the liquid.

FIG. 5 shows an alternative embodiment of the current invention utilizing multiple fluid chambers and syringes.

### DETAILED DESCRIPTION OF THE DRAWINGS

In the following discussion that address a number of embodiments and applications of the present invention, reference is made to the accompanying drawings that form a part hereof, and in which is shown by way of illustration specific to embodiments in which the invention may be practiced. It is to be understood that other embodiments may be utilized and changes may be made without departing from the scope of the present invention.

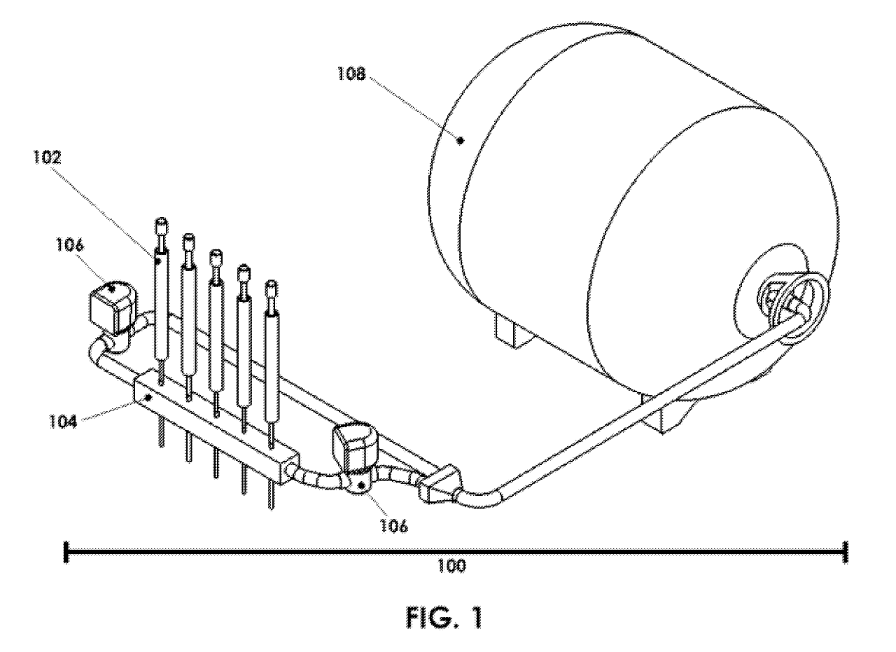

FIG. 1 shows the preferred embodiment of the current invention in a prospective view. FIG. 1 shows the dispensing apparatus 100 containing syringe 102, with syringe tip 101 inserted into fluid chamber 104. Valves 106 are strategically placed on each end of fluid chamber 104 controlling a flow of fluid supplied by a fluid source 108.

Syringe 102 here in the current embodiment is used to extract fluid from a source reservoir and transfer a desired amount to the target reservoir. Syringe 102 needs to be capable of aspirating a very small amount of liquid, thus, in the current embodiment a high precision bored glass syringe is used to achieve that goal. However, Syringe 102 can also be a high precision polyethylene, high precision quarts glass, high precision plastic, or any other material capable of aspirating a very small amount of liquid without departing from the scope of the present invention.

Using a syringe 102 is the preferred embodiment in the current invention based on its ability to dispense precise measurements of liquid in very small volumes; however, syringe 102 could also be a pipette that is capable of such small volume aspirations in the nano-liter range without departing from the scope of the present invention.

Syringe tip 101 here in the current embodiment is attached to the bottom of above mentioned syringe 102, and is partially enclosed by fluid chamber 104. Syringe tip 101 attaches to syringe 102 to provide a more precise volume for liquid to be aspirated from, usually in a nano-liter range; as the decreased diameter of syringe tip 101 is significantly smaller when compared to the diameter of syringe 102 allowing more precise measurements.

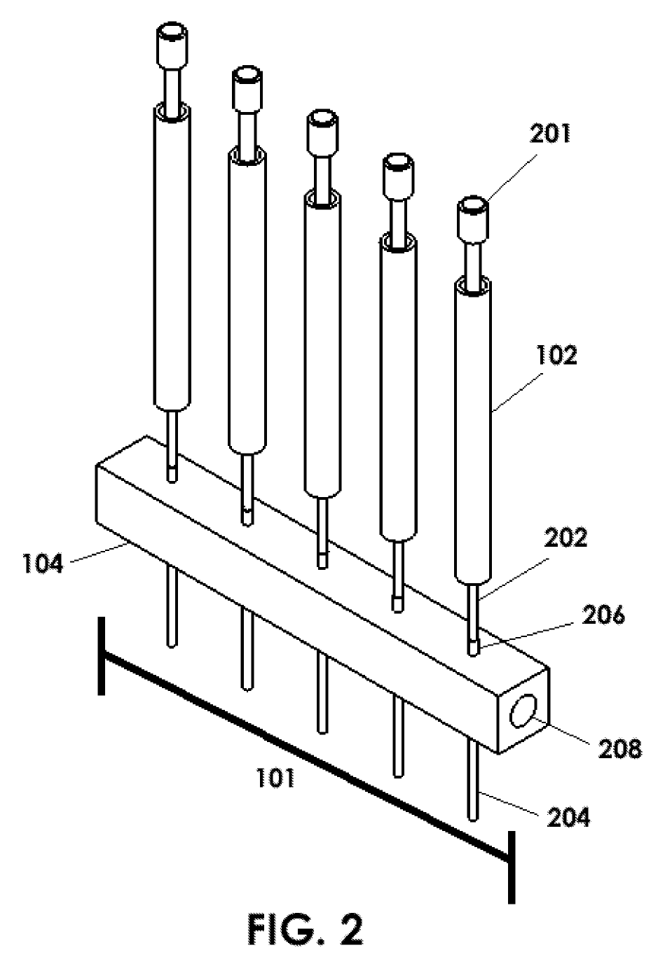

As shown in the current embodiment, Syringe tip 101 consists of a collapsible tubing portion that is enclosed by fluid chamber 104, and the collapsible tubing portion controls the discharge and aspiration of liquid from syringe tip 101. (see FIG. 2 below)

Fluid chamber 104 here in the current embodiment, as mentioned above, partially encloses syringe tip 101 to provide an area for the flow of fluid to compress syringe tip 101. Syringe tip 101 contain a collapsible portion which, in the current embodiment will collapse when a flow of fluid is introduced into fluid chamber 104, consequently causing air within syringe tip 101 to discharge out of syringe tip 101. The discharge of fluid within syringe tip occurs because the air trapped within the collapsible portion of syringe tip has nowhere to go when compressed, and is forced toward the syringe tip.

Fluid chamber 104 in the current embodiment supports five syringe tips 101, however fluid chamber 104 can contain one, two, three, four, five, six, seven, eight, or any number of syringe tip without departing from the scope of the present invention. Additionally, fluid chamber 104, in the current embodiment is made out of plastic for its strong structural rigidity; however, fluid chamber 104 can be made out of metal, wood, ceramic, or any other material capable of providing structural rigidity to syringe tips 101 without departing from the scope of the present invention.

Valves 106 in the current embodiment are juxtaposed at both sides of fluid chamber 104 to control the flow of fluid into fluid chamber 104. Valves 106 can be solenoid valves, as shown in the current embodiment; however, valves 106 can be a simple ball valve, hydraulic valve, gate valve, or any other valve that can control the flow of fluid into fluid chamber 104 without departing from the scope of the present invention.

In the current exemplary embodiment, there are two valves 106 juxtaposed at both sides of fluid chamber 104 to control the flow of fluid into fluid chamber 104. Having two valves 106 allows pressurized fluid to converge within fluid chamber 104 from both sides of fluid chamber 104, which will increase the effect of the pressurized fluid in collapsing the syringe tip 101. However, the same objective can be achieved utilizing only one valve 106 at one end of fluid chamber 104 allowing the pressurized fluid to simply pass through fluid chamber 104 instead converging within fluid chamber 104 without departing from the scope of the present invention.

In the current exemplary embodiment, fluid source 108 is used to provide the requisite flow of fluid to fluid chamber 104, which in term applies a pressure to collapsible syringe tip 206 (shown in FIG. 2), which in term discharges a fluid stored within syringe tip 101. Fluid source 108 in the current exemplary embodiment is pressurized and compressed air because of its ability to provide a high compression force upon a collapsible tubing quickly; however, other fluid sources of fluid such, water, nitrogen, hydrogen, or any other compressible fluid capable of generating the compression to be used without departing from the scope of the present invention.

FIG. 2 shows a detailed view of syringe 102, syringe tip 101, and fluid chamber 104. However, in this view, components such as plunger 201, first rigid section 202 of syringe tip 101, second rigid section 204 of syringe tip 101, collapsible portion 206 of syringe tip 101, and inlet 208 of fluid chamber 104 are shown for explanatory purposes.

Plunger 201 in the current embodiment is used to withdraw liquid into the syringe tip 101, utilizing a negative pressure created within the syringe 102. Plunger 201 in the current embodiment is made out of metal; however, plunger 201 can be made out of wood, plastic, ceramic or any other solid material without departing from the scope of the present invention.

Syringe tip 101 as shown here in the current exemplary embodiment comprises of the above mentioned first rigid portion 202, a second rigid portion 204, and a collapsible portion 206 connectively placed between the above first rigid portion 202 and second rigid portion 204.

First rigid portion 202 of the present embodiment is attached to proximal end of syringe 102 to provide structural rigidity to the syringe tip 101. Moreover, first rigid portion 202 help provide an attachment point from syringe tip 101 to syringe 102. Although first rigid portion 202 in the current embodiment is preferably a metallic material, it can be plastic, ceramic or any other material capable of providing structural rigidity without departing from the scope of the present invention.

Collapsible portion 206 of the present invention is connected directly beneath first rigid portion 202 of syringe tip 101 and above second rigid portion 204. Collapsible portion 206 of syringe tip 101, as indicated above, is enclosed by fluid chamber 104 to allow the flow of fluid to compress the collapsible portion 206 of syringe tip 101. As collapsible portion 206 is compressed, the air within collapsible portion 206 of syringe tip 101 is forced towards second rigid portion 204, thus discharging any liquid within second rigid portion 204; aspirating the desired liquid.

Collapsible portion 206 in the current embodiment can be made out of a rubber material for its elastic characteristics. However, collapsible portion 206 can be made out of plastic, polyethylene, cannula, or any other material with such elastic tendencies to collapse under pressure and return to its original shape without departing from the scope of the present invention.

Second rigid portion 204 of the present embodiment is attached to a distal end of syringe 102 to provide structural rigidity to the syringe tip 101. Second rigid portion 204 is used to hold a small desirable amount of liquid waiting to be discharged. Although second rigid portion 204 in the current embodiment is preferably a metallic material, it can be plastic, ceramic or any other material capable of providing structural rigidity without departing from the scope of the present invention.

Inlet 208 of the current invention is located at each end of fluid chamber 104 to allow the fluid to enter fluid chamber 104, thus creating the necessary pressure to collapse the collapsible portion 206 of syringe tip 101. Inlet 208 as shown in the current embodiment is circular in shape to accommodate the size and shape of the connecting tubes. However, inlet 208 can be square, triangular, or any other shape that is capable of allowing fluid through the system without departing from the scope of the present invention.

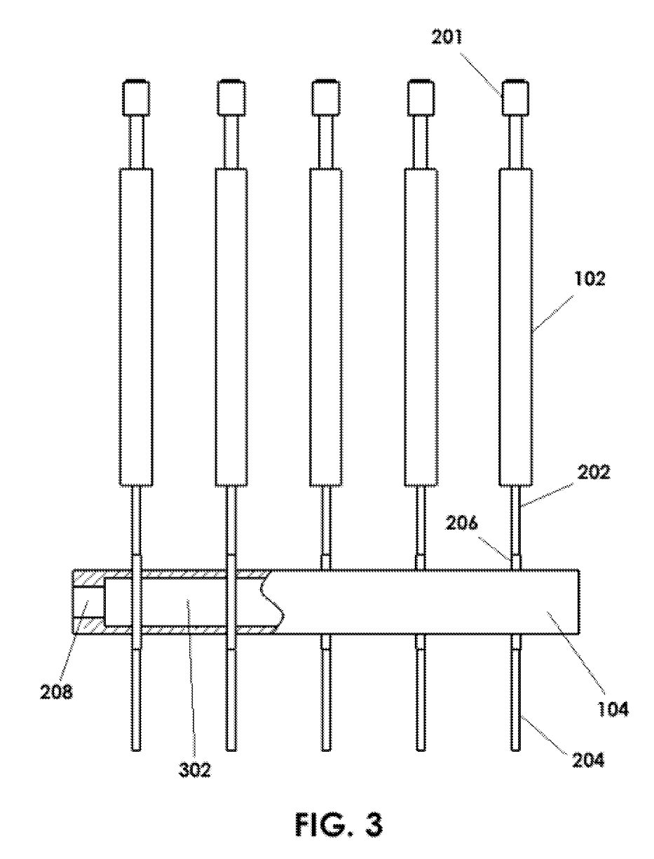

Turning now to FIG. 3 showing a partially sectioned cut-away view of the current invention. FIG. 3 shows the internal cavity 302 of fluid chamber 104.

Internal cavity 302 of the current exemplary embodiment provides a fluid tight area for the flow of fluid into fluid chamber 104. Internal cavity 302 can be cylindrical in shape to allow ease of compression, however, internal cavity 302 can be rectangular in shape or any other shape sufficient to encompass collapsible portion 206 of syringe tip 101 without departing from the scope of the present invention.

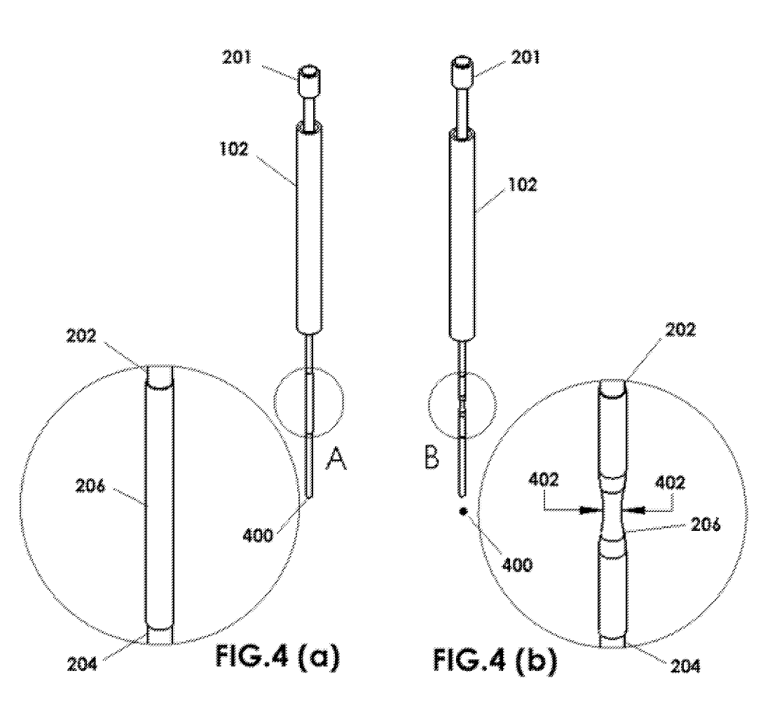

Turning now to FIG. 4(a) and FIG. 4(b) are enlarged views of collapsible portion 206 of syringe tip 101 before and during compression showing a compression force 402, causing liquid 400 to be discharged from second rigid portion 204 of syringe tip 101.

FIG. 4(a) shows syringe 102 in a rest state with liquid 400 at the tip of second rigid portion 204 of syringe tip 101 ready to be dispensed. Liquid 400 is generally a very small volume of liquid. Note in FIG. 4(a) that collapsible portion 206 is in its rest state, and is connected between first rigid portion 202 and second rigid portion 204.

Liquid 400 in the current embodiment is the amount of liquid that needs to be dispensed from syringe tip 101 of syringe 102. The amount of liquid 400 can be any volume that fits within second rigid portion 204. However, the maximum amount of liquid 400 that can be accommodated by the current apparatus is capped at the volume within collapsible portion 206. The maximum volume of liquid 400 is capped at the internal volume of collapsible portion 206 because that is the maximum amount of air that can be used to force liquid 400 out of second rigid portion 204 when collapsible portion 206 is compressed. Any volume exceeding that amount will not have sufficient air to discharge it out of the syringe tip 101.

Turning now to FIG. 4(b), syringe 102 is not in a collapsed state, with collapsible portion 206 pinched due to compression force 402 exerted on it by flow of fluid within fluid chamber 104. As shown in FIG. 4(b), the compression of collapsible portion 206 forces the fluid within collapsible portion 206 towards the bottom of syringe tip 101, causing liquid 400 to be ejected out of syringe tip 101 at a high speed towards a target receptacle without making contact with that target receptacle.

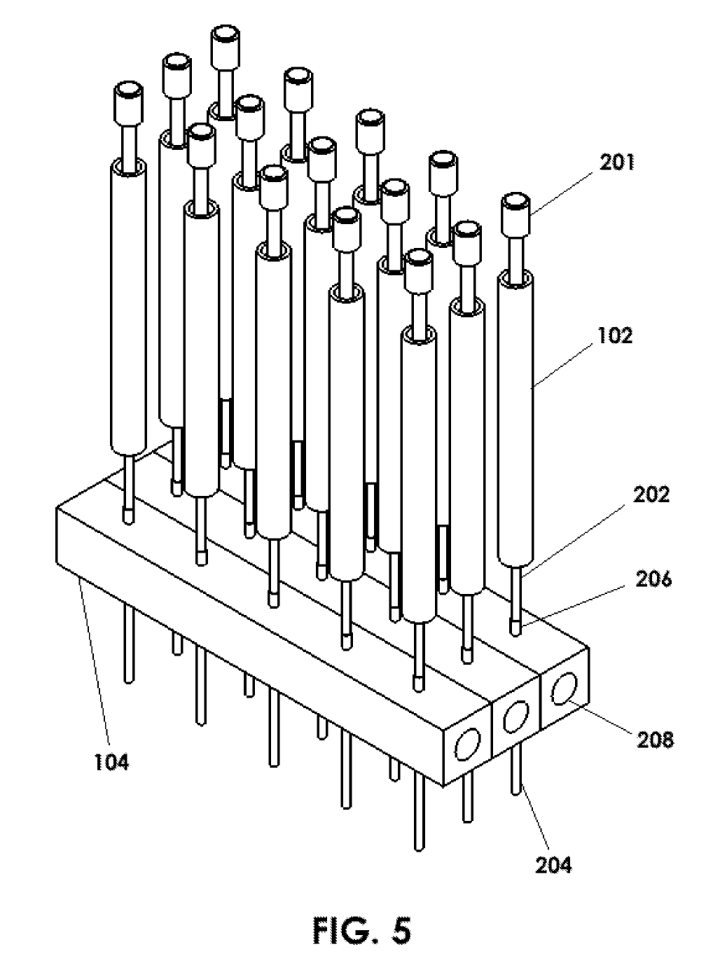

FIG. 5 shows an alternative embodiment of the current invention wherein multiple fluid chambers 104 can be combined, and connected to the same fluid source 108 to aspirate and dispense multiple liquid 400 samples from multiple syringes 102.

Here, in the current alternative embodiment, three fluid chamber 104 each having five receptacles for five syringes 102 have been combined together to form an array totaling fifteen syringes 102. However, additional fluid chamber 104 may be used to create any combination of syringes 102 as well, without departing from the scope of the present invention.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An apparatus for dispensing a liquid comprising:
a partially collapsible syringe tip;
a fluid chamber partially enclosing said partially collapsible syringe tip;
a set of valves juxtaposed at both ends of said fluid chamber controlling a flow of fluid into said fluid chamber; and
a compressed fluid source for supplying said flow of fluid;
wherein said flow of fluid exerts a force on said partially collapsible syringe tip to dispense said liquid from said syringe tip.

2. The apparatus of claim 1, wherein said partially collapsible syringe tip is further comprising:
a first rigid portion at a proximal end of said partially collapsible syringe tip;
a second rigid portion at a distal end of said partially collapsible syringe tip to dispense said liquid; and
a collapsible portion connectively placed between said first rigid portion and said second rigid portion adapted to be enclosed by said fluid chamber.

3. The apparatus of claim 2, wherein said fluid chamber encloses said collapsible portion of said partially collapsible syringe tip.

4. The apparatus of claim 3, wherein said force generated by said flow of fluid collapses said partially collapsible syringe tip at said collapsible portion.

5. The apparatus of claim 4, wherein a volume of air within said collapsible portion of said partially collapsible syringe tip ejects said liquid within said second rigid portion of said partially collapsible syringe tip.

6. The apparatus of claim 5, wherein said fluid chamber is capable of enclosing a plurality of partially collapsible syringe tips.

7. The apparatus of claim 6, wherein said fluid chamber is fluid tight.

8. The apparatus of claim 7, wherein said apparatus is capable of containing a plurality of fluid chambers.

9. The apparatus of claim 8, wherein said set of valves further comprises of a solenoid to control the flow of fluid into said fluid chamber.

10. A method of dispensing a liquid comprising:
enclosing a portion of a partially collapsible syringe tip in a fluid chamber;
opening a set of valves juxtaposed at both sides of said fluid chamber controlling a flow of fluid into said fluid tight chamber;
allowing said flow of fluid into said fluid chamber;
wherein said flow of fluid exerts a force on said partially collapsible syringe tip to dispense said liquid.

11. The method of claim 10, wherein said partially collapsible syringe tip is further comprising:
a first rigid portion at a proximal end of said partially collapsible syringe tip;
a second rigid portion at a distal end of said partially collapsible syringe tip to dispense said liquid; and
a collapsible portion connectively placed between said first rigid portion and said second rigid portion adapted to be enclosed by said fluid chamber.

12. The method of claim 11, wherein said fluid chamber encloses said collapsible portion of said partially collapsible syringe tip.

13. The method of claim 12, wherein said fluid chamber is capable of enclosing a plurality of partially collapsible syringe tips.

14. The method of claim 13, further comprising:
connecting a plurality of fluid chambers to said valves to create a plurality of fluid chambers.

15. An apparatus for dispensing a liquid comprising:
a fluid chamber partially enclosing a partially collapsible syringe tip;
said partially collapsible syringe tip further comprising:
a first rigid portion at a proximal end of said partially collapsible syringe tip,
a second rigid portion at a distal end of said partially collapsible syringe tip, and
a collapsible portion connectively placed between said first rigid portion and said second rigid portion adapted to be enclosed by said fluid chamber;
wherein said collapsible portion collapses when subjected to a pressurized fluid.

16. The apparatus of claim 15, further comprising:
a set of valves are juxtaposed at both sides of said fluid chamber to control a flow of fluid into said fluid chamber.

17. The apparatus of claim 16, further comprising:
a fluid source at each end of said set of valves to provide said pressurized fluid.

18. The apparatus of claim 17, wherein said apparatus is capable of containing a plurality of fluid chambers

19. The apparatus of claim 18, wherein said set of valves further comprises of a solenoid to control the flow of fluid into said fluid chamber
